(19) United States
(12) Patent Application Publication
(10) Pub. No.: US 2019/0031473 A1
(43) Pub. Date: Jan. 31, 2019

(54) LIFTING FASTENER

(71) Applicant: Choong Ho KIM, Bucheon-si, Gyeonggi-do (KR)

(72) Inventor: Choong Ho KIM, Bucheon-si, Gyeonggi-do (KR)

(21) Appl. No.: 16/072,560

(22) PCT Filed: Jan. 28, 2016
(86) PCT No.: PCT/KR2016/000938

§ 371 Date: Jul. 25, 2018

(30) Foreign Application Priority Data
Jan. 27, 2016 (KR) 10-2016-0009769

(51) Int. Cl. B66C 1/66; F16G 15/06

(52) U.S. Cl. CPC B66C 1/66; F16G 15/06

(57) ABSTRACT

Provided is a coupling tool for pulling, and the coupling tool for pulling includes: a body, through which a mounting hole passes; a pulling ring connected to the body such that a rope or a hook of a crane is caught by the pulling ring; and a coupling nut provided in the pulling ring and coupled to a bolt when the bolt is provided in an object-to-be-pulled. According to the present invention, in addition to a basic function of a deformation preventing part installed to support a pulling ring, a rotation space for a coupling nut may be secured while the pulling ring may be prevented from being pulled and deformed toward the coupling nut, considering that tensile force increases due to a force for lifting the pulling ring and a load of an object-to-be-pulled in a pulling process, in order to increase the tensile strength of the pulling ring.

### BACKGROUND OF THE INVENTION

### 1. Field of the Invention

The present invention relates to a coupling tool for pulling, and more particularly to a coupling tool for pulling that connects an object-to-be-pulled to a rope or a crane hook or the like when the object is pulled.

### 2. Description of the Related Art

As various construction and architecture methods have been developed recently, structures are often constructed while concrete structures of heavy weights are pulled through cranes.

For example, the concrete structures constructed in advance through a pre-casting method are located at a desired location by using cranes to be coupled to structures.

Then, because a crane and a concrete structure have to be temporarily coupled to each other to carry the concrete structure, an insertion anchor is buried in the interior of the concrete structure, a portion of the insertion anchor is exposed to the outside of the concrete structure, and a wire or a chain is connected to a ring in an eyebolt after the eyebolt is connected to the insertion anchor, in order to feed the concrete structure.

The technologies related to eyebolts for lifting a concrete structure of a heavy weight are disclosed in Korean Utility Model No. 20-0286069 and Korean Patent Application Publication No. 2003-0074001.

Hereinafter, a pre-eyebolt and an eyebolt having a semicircular head disclosed in Korean Utility Model No. 20-0286069 and Korean Patent Application Publication No. 2003-0074001 as conventional technologies will be described below briefly.

FIG. 1 is a perspective view illustrating a pre-eyebolt in Korean Utility Model No. 20-0286069 (hereinafter, ‘conventional technology 1’).

As can be seen in FIG. 1, the pre-eyebolt of conventional technology 1 is a bolt that is used by passing a fastening ring through holes of a bolt and a nut and connecting the fastening ring to a product or the like, and may prevent damage of the product when the product is lowered and raised by providing an angle by which a force may be distributed by separating a coupling tool of the eyebolt and the fastening ring.

However, according to the pre-eyebolt of conventional technology 1, the coupling tool is fixed in a state in which a hook of the crane or the like is caught by the coupling ring, and a load is concentrated in the coupling ring that is a connecting portion of the hook of the crane is concentrated to be deformed inwards.

FIG. 2 is a front view illustrating an eyebolt having a semicircular head in Korean Patent Application Publication No. 2003-0074001 (hereinafter, ‘conventional technology 2’).

As illustrated in FIG. 2, the eyebolt 1 having a semicircular head according to conventional technology 2 includes a semicircular bolt head 2 having a semicircular space 3 in the interior thereof, protruding upwards in a semicircular shape, and having a rectangular cross-section, a planar head lower end 4 having a planar shape to contact a weight on a plane on a lower side of the semicircular bolt head 2, and an screw part 5 having a screw and protruding from a center of the planar head lower end 4 to the lower side. The planar head lower end 4 has an extent (width) that is three or more times as large as the diameter of the screw part 5 to sufficiently plane-contact the weight.

However, as in conventional technology 1, in the eyebolt having a semicircular head according to conventional technology 2, an object is fixed to the screw part 5 in a state in which a hook of a crane or the like is caught by the bolt head 2, but a load is concentrated in the bolt head 2 and accordingly, the opposite side ends of the bolt head 2 are deformed inwards so that a solution for the problem is requested.

### PRIOR TECHNICAL DOCUMENTS

### Patent Documents

(Patent document 0001) Korean Utility Model No. 20-0286069

(Patent document 0002) Korean Patent Application Publication No. 2003-0074001

### SUMMARY OF THE INVENTION

The present invention has been made in an effort to solve the above-mentioned problems, and provides a coupling tool for pulling, by which, in addition to a basic function of a deformation preventing part installed to support a pulling ring, a rotation space for a coupling nut may be secured while the pulling ring may be prevented from being pulled and deformed toward the coupling nut, considering that tensile force increases due to a force for lifting the pulling ring and a load of an object-to-be-pulled in a pulling process, in order to increase the tensile strength of the pulling ring.

The present invention also provides a coupling tool for pulling, by which an object-to-be-pulled is coupled by a coupling bolt mounted in the coupling tool for pulling when a coupling hole is provided in the object, the object is coupled by a coupling nut in a state in which the coupling bolt is separated from the coupling tool for pulling when a bolt is provided in the object, and a deformation preventing part that interferes is omitted for efficient use when the length of the coupling bolt mounted on the coupling tool for pulling or the bolt provided in the object is long.

In accordance with an aspect of the present invention, there is provided a coupling tool for pulling comprising: a body, through which a mounting hole passes; a pulling ring connected to the body such that a rope or a hook of a crane is caught by the pulling ring; and a coupling nut provided in the pulling ring and coupled to a bolt when the bolt is provided in an object-to-be-pulled.

The coupling tool may further comprise: a deformation preventing part formed on opposite surfaces of opposite ends of the pulling ring to prevent deformation of the pulling ring.

The coupling tool may further comprise: a coupling bolt selectively mounted on the mounting hole and the coupling nut to adjust a coupling degree below the body when a nut is provided in the object-to-be-pulled.

The deformation preventing part may have a concave arc shape.

The deformation preventing part may be fixed to or detachably mounted to opposite ends of the pulling ring.

The coupling nut may be fixed to an upper surface of the body.

According to the present invention, in addition to a basic function of a deformation preventing part installed to support a pulling ring, a rotation space for a coupling nut may be secured while the pulling ring may be prevented from being pulled and deformed toward the coupling nut, considering that tensile force increases due to a force for lifting the pulling ring and a load of an object-to-be-pulled in a pulling process, in order to increase the tensile strength of the pulling ring. An object-to-be-pulled is coupled by a coupling bolt mounted in the coupling tool for pulling when a coupling hole is provided in the object, the object is coupled by a coupling nut in a state in which the coupling bolt is separated from the coupling tool for pulling when a bolt is provided in the object, and a deformation preventing part that interferes is omitted for efficient use when the length of the coupling bolt mounted on the coupling tool for pulling or the bolt provided in the object is long.

### BRIEF DESCRIPTION OF THE DRAWINGS

FIG. 1 is a perspective view illustrating a pre-eyebolt according to conventional technology 1;

FIG. 2 is a front view illustrating an eyebolt having a semicircular head according to conventional technology 2;

FIG. 3 is an exploded perspective view illustrating a coupling tool for pulling according to a first embodiment of the present invention;

FIG. 4 is a front view illustrating a state in which the coupling tool for pulling according to the first embodiment of the present invention is fixed to an object-to-be-pulled;

FIG. 5 is a perspective illustrating a state in which the coupling tool for pulling according to the first embodiment of the present invention is caught by a crane hook after the coupling tool for pulling is installed in an object-to-be-pulled;

FIG. 6 is an exploded perspective view illustrating a coupling tool for pulling according to a second embodiment of the present invention;

FIG. 7 is a front view illustrating a state in which the coupling tool for pulling according to the second embodiment of the present invention is fixed to an object-to-be-pulled;

FIG. 8 is a front view illustrating a state in which the coupling tool for pulling according to a third embodiment of the present invention is fixed to an object-to-be-pulled.

### DETAILED DESCRIPTION OF THE INVENTION

Hereinafter, exemplary embodiments of the present invention will be described in detail with reference to the accompanying drawings so that those skilled in the art to which the present invention pertains may easily carry out the invention. However, the present invention may be implemented in various different forms, and is not limited to the embodiments. The same reference numerals are given to the similar parts throughout the specification.

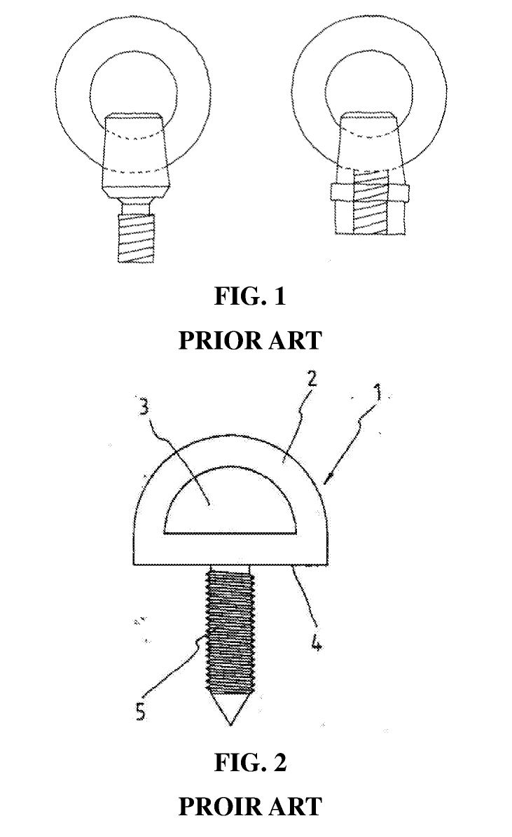

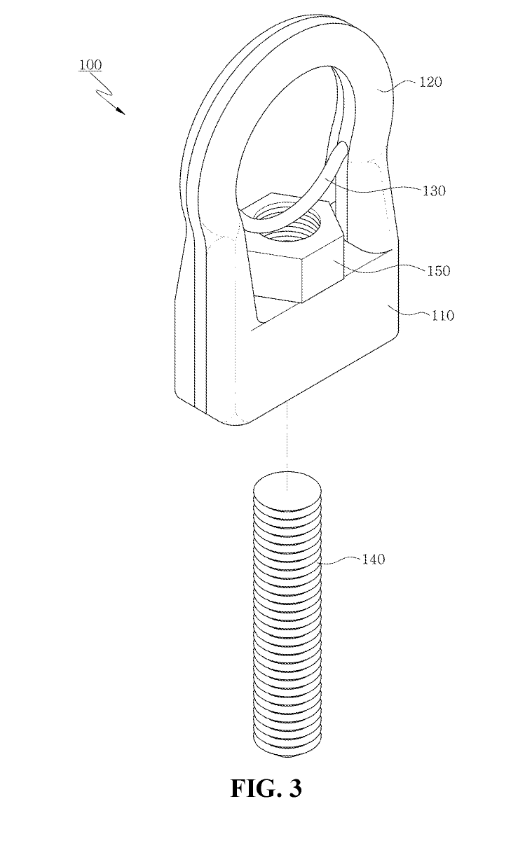

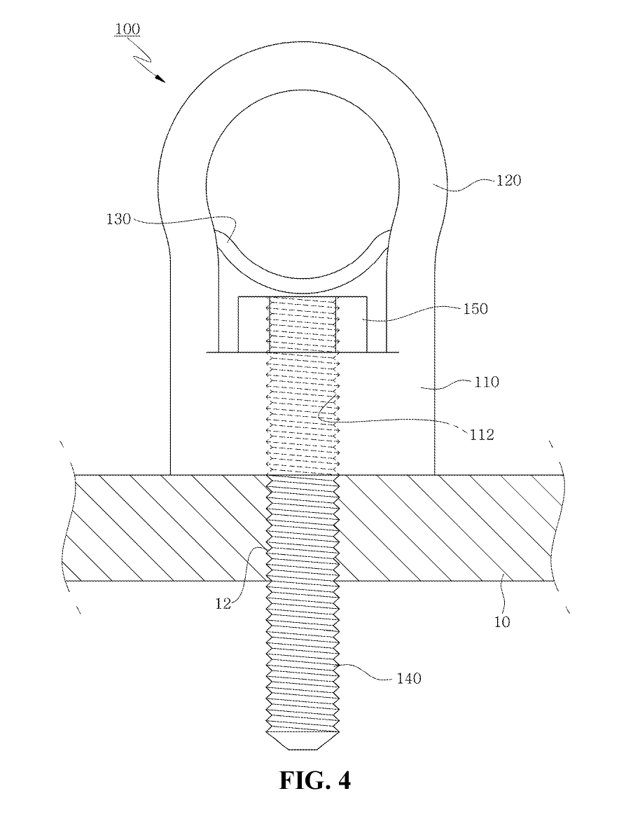

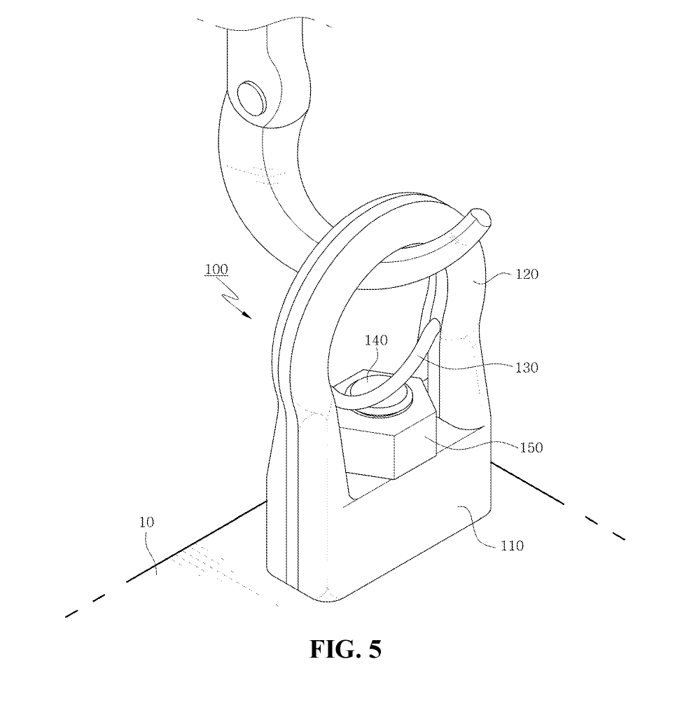

Hereinafter, in a description of a configuration of the present invention made with reference to the accompanying drawings, FIG. 1 is a perspective view illustrating a pre-eyebolt according to conventional technology 1. FIG. 2 is a front view illustrating an eyebolt having a semicircular head according to conventional technology 2. FIG. 3 is an exploded perspective view illustrating a coupling tool for pulling according to a first embodiment of the present invention. FIG. 4 is a front view illustrating a state in which the coupling tool for pulling according to the first embodiment of the present invention is fixed to an object-to-be-pulled. FIG. 5 is a perspective illustrating a state in which the coupling tool for pulling according to the first embodiment of the present invention is caught by a crane hook after the coupling tool for pulling is installed in an object-to-be-pulled.

According to the drawings, the coupling tool 100 for pulling according to the first embodiment of the present invention includes a body 110, a pulling ring 120, a deformation preventing part 130, a coupling bolt 140, and a coupling nut 150.

The body 110 has a rectangular shape, and a mounting hole 112 that is vertical is formed on upper and lower surfaces of the body 110.

Meanwhile, the mounting hole 112 has a screw thread on an inner peripheral surface thereof to be fixed and coupled to the coupling bolt 140, which will be described below.

The pulling ring 120 is integrally formed with the body 110 at an upper portion of the body 110 through casting or is coupled to the body 110 through welding or the like after the body 110 and the pulling ring 120 are manufactured through casting, respectively, so that a rope or a hook of a crane is coupled to the pulling ring 120 when the object-to-be-pulled 10 is moved through the coupling tool 100 for pulling.

Further, the pulling ring 120 includes a pair of linear connecting parts that extend from an upper surface of the body 110 in parallel and a ring connecting part that connects the pair of linear connecting parts.

Meanwhile, although not illustrated in the drawings, a plurality of anti-slide bosses may be formed on a surface of the ring connecting part to improve fixing force while preventing movement of the pulling ring 120 when a rope or a hook of a crane is connected to the pulling ring 120.

The deformation preventing part 130 is welded to an opposite surface of a connecting point of the linear connecting parts and the ring connecting parts of the pulling ring 120, and may prevent the linear connecting parts from being deformed inwards while a load is concentrated in a part of the ring connecting part, which contacts the hook of the crane when the coupling bolt 140 is fixed to the object 10 in a state in which the hook of the crane is caught by the ring connecting part.

Then, the deformation preventing part 130 has a concave arc shape and is preferably formed of a material of high strength.

Further, it is exemplified that the deformation preventing part 130 is fixed to the opposite surface of the connecting point of the linear connecting parts and the ring connecting part of the pulling ring 120.

A headless wrench bolt which is mounted in the mounting hole 112 of the body 110 and of which a coupling degree with the mounting hole 112 may be adjusted below the body 110 is applied as the coupling bolt 140, and a tool insertion recess may be formed on the upper surface of the coupling bolt 140.

That is, the coupling bolt 140 is provided to be elevated along the mounting hole 112 of the body 110, and an upper end of the coupling bolt 140 is coupled to the body 110 through the mounting hole 112 and a lower end of the coupling bolt 140 is coupled to the coupling hole 12 of the object 10 so that the body 110 is fixed to the object 10.

In particular, the coupling bolt 140 delivers a load that is delivered during the pulling to both the pulling ring 120 and the body 110 while fixing the object 10 because it is coupled to the coupling nut 150 disposed in the body 110 while passing through the object 10 vertically.

Further, because the coupling bolt 140 does not have a bolt head, it may be coupled from a lower side of the mounting hole 112 to an upper side of the mounting hole 112 when the interval between the body 110 and the pulling ring 120 is small, and thereafter, the coupling bolt 140 may be coupled to the coupling nut 150 fixed to the body 110.

Further, the coupling bolt 140 ma adjust a coupling degree through a tool, such as a wrench, when the tool insertion recess is formed on the upper surface of the coupling bolt 140.

In this way, because the coupling bolt 140 does not have a bolt head while the length of the coupling bolt 140 is large within a range in which the pulling ring 120 is not interfered, the coupling bolt 140 may be coupled from the lower side of the body 110 when it is difficult to couple the coupling bolt 140 from the upper side of the body 110.

Further, the coupling bolt 140 may be a bolt having a bolt head that is manufactured by coupling the coupling bolt 140 to a coupling nut 150 in a state in which the coupling bolt 140 is coupled to the mounting hole 112 of the body 110 in advance and welding an upper surface of the coupling bolt 140, which is adjacent to the coupling nut 150. This may be a bolt that is manufactured by coupling the coupling bolt 140 and the coupling nut 150 to the body 110 in advance and welding the coupling bolt 140 and the coupling nut 150 later.

The coupling nut 150 has a screw thread on an inner peripheral surface thereof to be coupled to an upper end of the coupling bolt 140 while being disposed in the interior of the pulling ring 120, more particularly, between a pair of linear connecting parts.

Meanwhile, the coupling bolt 140 and the coupling nut 150 are formed of a material of an excellent strength, such as alloy steel, to improve durability and support pulling force regardless of an upward direction or a lateral direction that is vulnerable as compared with the upward direction.

Further, the coupling nut 150 may be fixed to the upper surface of the body 110, through welding or the like.

Accordingly, a process of installed the coupling tool 100 for pulling according to the first embodiment of the present invention will be described below.

First, after a hole is formed in the object 10, to which the coupling tool 100 for pulling is coupled, such that the bolt body of the coupling bolt 140 may pass through the hole, the bolt body of the coupling bolt 140 is inserted into the hole of the object 10 from the lower side to the upper side to be mounted on the object 10.

Next, the coupling bolt 140 is coupled to the coupling nut 150 by rotating the coupling bolt 140 after the bolt body passes through the mounting hole 112.

Then, the body 110 may be firmly fixed to the object 10 through the coupling nut 150 coupled to the coupling bolt 140 and deliver a load to the upper and lower sides to prevent a concentrated load from being delivered to a part of the coupling tool 100.

Next, the object 10 is carried by pulling the object 10 to a specific site after a rope or a hook of a crane is mounted on the pulling ring 120 formed at an upper portion of the body 110 of the coupling tool 100 for pulling.

Meanwhile, the deformation preventing part 130 is provided on opposite surfaces of connection points of the pulling ring 120 so that the linear connecting part may be supported such that the tensile strength of the pulling ring 120 may be increased by the deformation preventing part 130 when the coupling bolt 140 is fixed to the object 10 in a state in which the hook of the crane is caught by the ring connecting part, and in addition, a phenomenon in which the pulling ring is pulled and deformed toward the coupling nut may be prevented and a rotation space of the coupling nut 140 may be secured, considering that a tensile force is increased by a force for lifting the pulling ring 120 and a load of the object 10 in the pulling process.

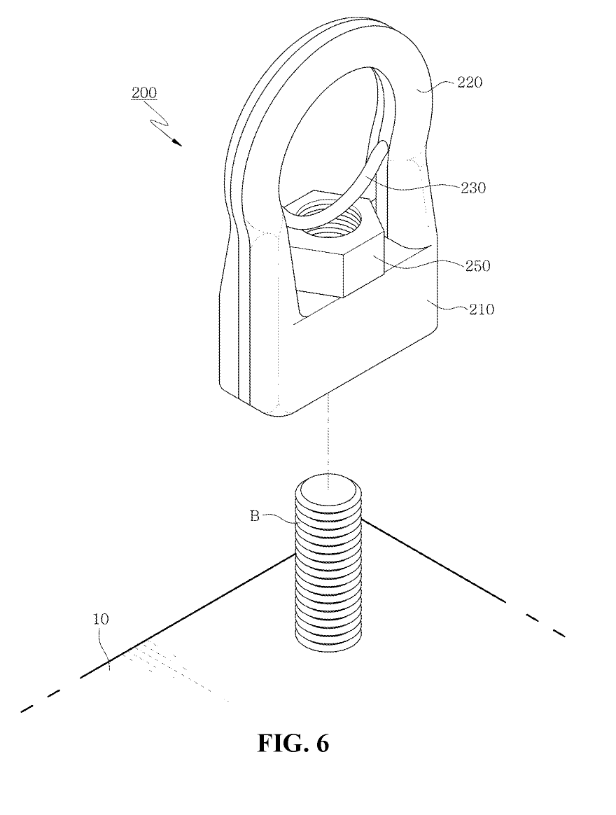

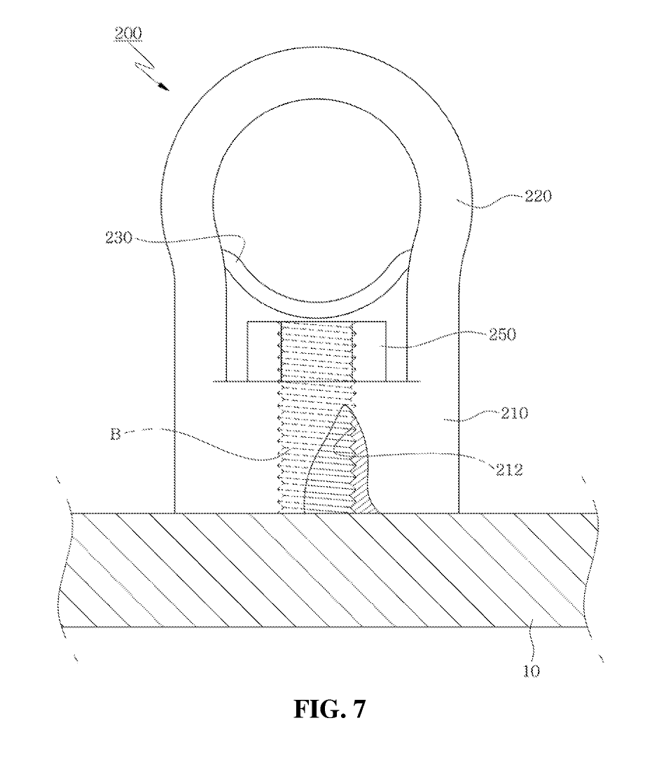

FIG. 6 is an exploded perspective view illustrating a coupling tool for pulling according to a second embodiment of the present invention, and FIG. 7 is a front view illustrating a state in which the coupling tool for pulling according to the second embodiment of the present invention is fixed to an object-to-be-pulled.

According to the drawings, the coupling tool 200 for pulling according to the second embodiment of the present invention includes a body 210, a pulling ring 220, a deformation preventing part 230, and a coupling nut 250, and the body 110, the pulling ring 220, the deformation preventing part 230, and the coupling unit 250 has the same structure and function as those of the previous embodiment and a detailed description thereof will be omitted.

Meanwhile, unlike in the first embodiment, in the coupling tool 200 for pulling according to the present embodiment, when a bolt B is provided in an object 10, a coupling nut 250 fixed onto the body 210 is directly coupled to the bolt B while the coupling bolt of the previous embodiments is omitted.

Here, reference numeral 212 is a mounting hole.

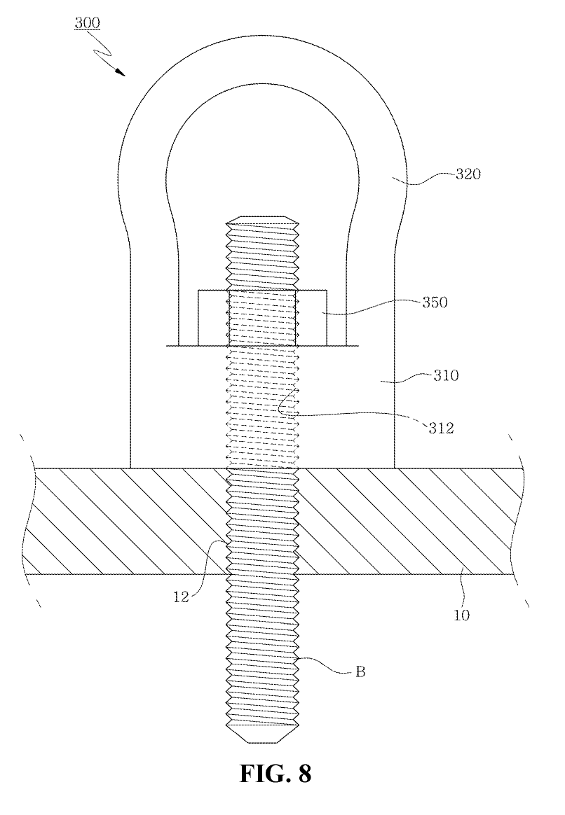

FIG. 8 is a front view illustrating a state in which the coupling tool for pulling according to a third embodiment of the present invention is fixed to an object-to-be-pulled.

According to the drawings, the coupling tool 300 for pulling according to the third embodiment of the present invention includes a body 310, a pulling ring 320, a coupling bolt 340, and a coupling nut 350, and the body 310, the pulling ring 320, the coupling bolt 340, and the coupling unit 350 has the same structure and function as those of the first embodiment and a detailed description thereof will be omitted.

Meanwhile, unlike in the first and second embodiments, in the present embodiment, when the bolt B provided in the object 10 or the coupling bolt 340 mounted on the coupling tool 300 for pulling is long to protrude above the coupling nut 350, the deformation preventing part that interferes the protrusion may be omitted.

Here, reference numeral 312 is a mounting hole.

Although the present invention has been described with reference to the limited embodiments and the drawings, the present invention is not limited to the embodiments, but various corrections and modifications may be made from the description by those skilled in the art to which the present invention pertains.

Therefore, the scope of the present invention is not limited to the described embodiments, and has to be determined by equivalents to the claims as well as the claims.

1. A coupling tool for pulling, comprising:
a body, through which a mounting hole passes;
a pulling ring integrally formed on opposite sides of the body and connected to a rope or a hook of a crane to be caught by the rope or the hook;
a bolt located in the pulling ring, and coupled to a headless bolt when the headless bolt is provided in an object-to-be-pulled or coupling to a cylindrical headless coupling bolt provided to adjust coupling degree from the lower side of the body when a nut is provided in the object-to-be-pulled; and
a deformation preventing part provided on opposite surfaces of a connecting point of a linear connecting part of the pulling ring and arc-shaped ring connecting parts extending from opposite upper ends of the linear connecting part to be detachably provided separately from the pulling ring to prevent deformation of the pulling ring,
wherein a screw thread is formed on an inner peripheral surface of the mounting hole to improve a coupling force with the bolt or the coupling bolt, and
wherein the deformation preventing part is formed of a material of a high strength as compared with that of the pulling ring and has an arc shape that is convex toward the coupling nut.

2. The coupling tool of claim 1, wherein the coupling nut is fixed to an upper surface of the body.

3. The coupling tool of claim 1, further comprising:
a coupling bolt selectively mounted on the mounting hole and the coupling nut to adjust a coupling degree below the body when a nut is provided in the object-to-be-pulled.

4. The coupling tool of claim 2, wherein the deformation preventing part has a concave arc shape.

5. The coupling tool of claim 2, wherein the deformation preventing part is fixed to or detachably mounted to opposite ends of the pulling ring.

6. The coupling tool of claim 1, wherein the coupling nut is fixed to an upper surface of the body.
